(19) United States
(12) Patent Application Publication
(10) Pub. No.: US 2026/0189835 A1
(43) Pub. Date: Jul. 2, 2026

(54) Microphone Module for a Wearable Device

(71) Applicant: Harman International Industries, Incorporated, Stamford, CT (US)

(72) Inventors: Taoliang LI, Shenzhen (CN); Zhengchun ZHANG, Shenzhen (CN)

(73) Assignee: Harman International Industries, Incorporated, Stamford, CT (US)

(21) Appl. No.: 19/433,232

(22) Filed: Dec. 26, 2025

(30) Foreign Application Priority Data
Dec. 31, 2024 (CN) 202411987035.9

(51) Int. Cl. H04R 1/08

(52) U.S. Cl. CPC H04R 1/086; H04R 2410/07

(57) ABSTRACT

The present invention provides a microphone module, comprising: a housing; a microphone unit disposed in the housing and located at the bottom of the housing; a top sound hole area located at the top of the housing; a first windproof net covering the top sound hole area; a windproof cotton unit disposed between the top sound hole area and the microphone unit; and a second windproof net disposed between the windproof cotton unit and the microphone unit. The present invention also provides a wearable device, including the microphone module as described above. This invention provides a microphone module with excellent windproof and noise-reducing functions, which can ensure clear call quality in windy weather with wind speeds of up to 9 m/s or even 11 m/s. In addition, the microphone module is small and modular, and can be embedded in wearable devices of any shape.

### CROSS REFERENCE

Priority is claimed to application serial no. 202411987035.9, filed Dec. 31, 2024, in China, the disclosure of which is incorporated in its entirety by reference.

### TECHNICAL FIELD

The present invention involves a microphone module and a wearable device including the microphone module.

### BACKGROUND

Currently, an increasing number of wearable devices have emerged in people's lives, including smart helmets, smart glasses, TWS earbuds, OWS earbuds, sports earbuds, headphones, hearing aids, smart watches, and the like. With the increase in people's demands, these wearable devices have also become increasingly diverse in functions. For example, many wearable devices need to incorporate voice call functionality, and thus need to be equipped with a microphone.

In addition, a user may use a wearable device outdoors or while engaging in sports, such as in windy weather, at the seaside, in the mountains, etc., or when the user is running, driving a car with car windows open, etc. In this case, the moving air flow will interfere with the sound pickup effect of a microphone in the wearable device, resulting in the other party in the call with the user being unable to clearly hear the user's voice.

In response to this situation, existing technologies have proposed wind noise reduction measures to be added to microphones. However, even with the addition of the wind noise reduction measures, the current microphones can only basically meet the call requirements at a wind speed of 5 m/s.

Therefore, there is a need in the art for a microphone module that can clearly pick up the user's voice during voice calls even in conditions of higher wind speeds.

### SUMMARY OF THE INVENTION

In response to the problems and demands mentioned above, the present disclosure proposes a novel technical solution that solves the aforementioned problems and brings about other technical effects by adopting the following technical features.

The present invention provides a microphone module, comprising: a housing; a microphone unit disposed in the housing and located at the bottom of the housing; a top sound hole area located at the top of the housing; a first windproof net covering the top sound hole area; a windproof cotton unit disposed between the top sound hole area and the microphone unit; and a second windproof net disposed between the windproof cotton unit and the microphone unit.

Preferably, the windproof cotton unit has a density greater than 25 kg/m³.

Preferably, the windproof cotton unit has a microporous structure including a plurality of micropores, and the pore diameter of each micropore ranges from 1 μm to 1 mm.

Preferably, the windproof cotton unit comprises ceramic sponge, open-cell foamed plastic or sponge rubber.

Preferably, a surface of the windproof cotton unit opposite to the first windproof net includes a plurality of protrusions or a plurality of recesses.

Preferably, a surface of the windproof cotton unit opposite to the first windproof net includes a plurality of protrusions and a plurality of recesses, wherein the plurality of protrusions and the plurality of recesses form a corrugated texture, and the plurality of protrusions constitute crests of the corrugated texture, and the plurality of recesses constitute troughs of the corrugated texture, wherein the shapes of the crests and troughs are one of arc-shaped, triangular, sinusoidal, or square.

Preferably, the top sound hole area has a circular shape and a diameter D of 0.15-0.55 mm.

Preferably, the top sound hole area has a polygonal shape, and a circumcircle diameter or an incircle diameter of the polygonal shape is 0.15-0.55 mm.

Preferably, the top sound hole area includes a plurality of sub-sound holes, and wherein each sub-sound hole has a polygonal shape, and a circumcircle diameter or an incircle diameter of the polygonal shape of each sub-sound hole is less than or equal to 0.05 mm; or each sub-sound hole has a circular shape and a diameter less than or equal to 0.05 mm.

Preferably, the top sound hole area is formed by machining a top wall of the housing, or, the microphone module comprises a sound hole plate that is connected to a top opening of the housing and includes the top sound hole area.

Preferably, one or both of the first windproof net and the second windproof net have a plurality of net holes, each net hole having a circular shape and a diameter less than or equal to 0.05 mm, or each net hole having a polygonal shape and a circumcircle diameter or an incircle diameter of the polygonal shape being less than or equal to 0.05 mm.

Preferably, the housing is integrally formed of metal material, and the first windproof net and the second windproof net are made of metal material.

The present invention also provides a wearable device, including the microphone module as described above.

This invention provides a microphone module with excellent windproof and noise-reducing functions, which can ensure clear call quality in windy weather with wind speeds of up to 9 m/s or even 11 m/s. In addition, the microphone module is small and modular, and can be embedded in wearable devices of any shape.

### BRIEF DESCRIPTION OF THE DRAWINGS

FIG. 1 is a schematic diagram of a microphone module and an enlarged view of a top sound hole area according to a preferred embodiment of the present invention; and

FIG. 2 is a cross-sectional view of a windproof cotton unit according to a preferred embodiment of the present invention.

### DETAILED DESCRIPTION OF EMBODIMENTS

To make objectives, technical solutions, and advantages of the present disclosure clearer, the technical solutions of the embodiments of the present disclosure are described clearly and completely hereinafter with reference to the accompanying drawings of the embodiments of the present disclosure. The same reference numerals in the accompanying drawings represent the same components. It should be noted that the described embodiments are only a part of the embodiments of the present disclosure, rather than all the embodiments. Based on the embodiments of the present disclosure, all other embodiments derived by those of ordinary skills in the art without any creative efforts fall within the protection scope of the present disclosure.

Compared with the embodiments shown in the accompanying drawings, feasible embodiments within the scope of the present disclosure may have fewer components, other components not shown in the accompanying drawings, different components, components arranged differently, or components with different connections, etc. In addition, two or more components in the accompanying drawings may be implemented in a single component, or a single component shown in the accompanying drawings may be implemented as multiple separate components.

Unless otherwise defined, the technical terms or scientific terms used here should have the ordinary meanings understood by those of ordinary skills in the field of the present disclosure. The words “first”, “second”, and the like used in the specification and claims of the disclosed patent application do not indicate any order, quantity, or importance, but are only used to distinguish different components. When the number of components is not specified, the number of components can be one or more; similarly, words such as “a”, “the”, and “said” do not necessarily indicate a quantity limitation. Similar words “including”, “comprising”, and the like mean that the element or object preceding the words includes the elements or objects listed after the words and equivalents thereof, but do not exclude other elements or objects. Similar words such as “installed”, “disposed”, “connected” and “connecting” are not limited to physical or mechanical installation, disposition, connection, but may include electrical installation, disposition, connection, whether direct or indirect. “Top”, “bottom”, “upper”, “lower”, “left”, “right” and the like are only used to indicate the relative positional relationships when the device is in use or the positional relationships shown in the accompanying drawings. When an absolute position of an object being described changes, the relative position relationship may also change accordingly.

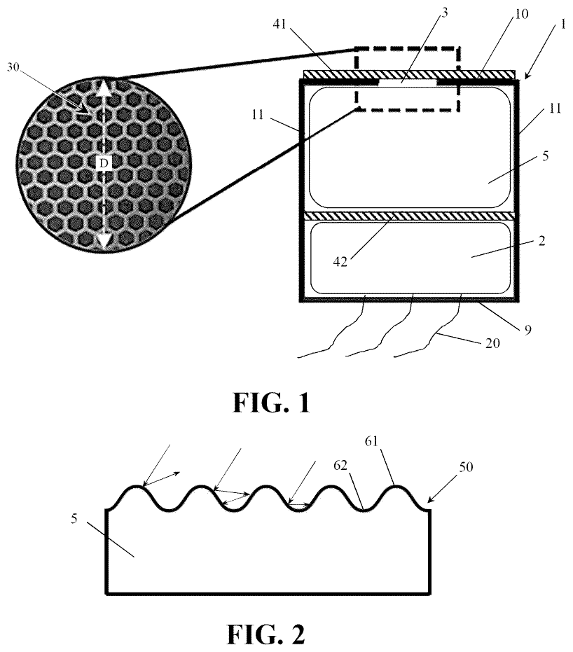

The microphone module according to the present invention will now be described with reference to the accompanying drawings. The preferred embodiment of FIG. 1 provides a microphone module, comprising: a housing 1; a microphone unit 2 disposed in the housing 1 and located at the bottom of the housing 1; and a top sound hole area 3 located at the top of the housing 1. The top sound hole area 3 may be provided as a through hole or may include a plurality of sub-sound holes (as described below), primarily for allowing sound to pass through and be transmitted to the microphone unit 2. For example, the microphone unit 2 may be fixedly installed to the bottom of the housing 1, and necessary sealing devices, support devices, shielding devices, etc. may be provided for the microphone unit 2. Electrical leads 20 of the microphone unit 2 may be led out from the bottom to connect to circuit components of the wearable device.

In addition, to achieve a better windproof and noise-reducing effect, the microphone module further comprises a first windproof net 41 covering the top sound hole area 3; a windproof cotton unit 5 disposed between the top sound hole area 3 and the microphone unit 2; and a second windproof net 42 disposed between the windproof cotton unit 5 and the microphone unit 2. It should be understood that the first windproof net 41, the windproof cotton unit 5, and the second windproof net 42 may be installed sequentially from the bottom of the housing 1, and then the microphone unit 2 is installed. The housing 1 may also include a cover plate 9 for sealing its bottom, which may be installed into an opening of the housing 1 after all the components of the microphone module have been assembled into the housing 1.

The microphone module of the present invention adds windproof and noise-reducing means. For example, when making voice calls in windy weather, the sound can pass through the first windproof net 41, the top sound hole area 3, the windproof cotton unit 5, and the second windproof net 42 to enter and reach the microphone unit 2 normally. At the same time, the wind blowing towards the microphone module is first scattered by the first windproof net 41, and the wind speed will also be reduced; and the further blown-in wind will also be subjected to greater obstruction when it encounters the windproof cotton unit 5. Furthermore, even if a portion of the wind can still pass through the windproof cotton, it will be scattered and decelerated again by the second windproof net 42. During this process, the sound can reach the microphone unit 2 with almost no loss, while wind noise is almost completely attenuated. Tests have shown that the microphone module according to the present invention can maintain clear calls under wind speeds of 9 m/s or even 11 m/s.

More preferably, to further ensure the superior windproof and noise-reducing effect of the present invention, the windproof cotton unit 5 may have a density greater than 25 kg/m³. Based on this, the density of the windproof cotton unit 5 may also be kept as low as possible to avoid excessively increasing the weight of the microphone module.

Additionally, the windproof cotton unit 5 preferably has a microporous structure including a plurality of micropores. The smaller the micropores, the better the windproof effect. At the same time, considering that a clear voice call still needs to be ensured, the pore size of each micropore is preferably set to 1 μm to 1 mm.

More preferably, the windproof cotton unit 5 may comprise ceramic sponge, open-cell foamed plastic or sponge rubber.

A surface 50 of the windproof cotton unit 5 opposite to the first windproof net 41 may preferably include a plurality of protrusions 61 or a plurality of recesses 62.

For example, referring to the cross-sectional view of FIG. 2, the surface 50 of the windproof cotton unit 5 opposite to the first windproof net 41 may have both a plurality of protrusions 61 and a plurality of recesses 62, and the plurality of protrusions 61 and the plurality of recesses 62 form a corrugated texture. In this case, the plurality of protrusions 61 form the crests of the corrugated texture, and the plurality of recesses 62 form the troughs of the corrugated texture. The shapes of the crests and troughs are one of arc-shaped, triangular, sinusoidal, or square.

Although FIG. 2 shows an embodiment of continuously formed corrugated protrusions and recesses, it should be understood that the protrusions and recesses can be implemented individually. For example, there may be only provided a plurality of protrusions 61, such as spherical protrusions, cylindrical protrusions, and pyramidal protrusions, on a surface (e.g., a flat surface) of the windproof cotton unit 5 opposite to the first windproof net 41; or there may be only provided a plurality of recesses 62, such as spherical recesses, cylindrical recesses, and pyramidal recesses, on a surface (e.g., a flat surface) of the windproof cotton unit 5 opposite to the first windproof net 41.

By providing such protrusions 61/recesses 62, the wind entering from the top sound hole area 3 will change direction at the protrusions 61, as shown by the arrows in FIG. 2. The wind may be reflected multiple times between the protrusions and the recesses, and some air may even be reflected back towards the top sound hole area 3, thereby creating a space for air turbulence between the top sound hole area 3 and the windproof cotton unit 5, further increasing the blocking and attenuation effect on the wind.

More preferably, the windproof cotton unit 5 includes a plurality of windproof cotton sub-units stacked in a direction from the top of the housing toward the bottom.

Referring back to FIG. 1, as shown in the enlarged view, the top sound hole area 3 may have a circular shape and a diameter D of 0.15-0.55 mm. According to a preferred embodiment not shown, the top sound hole area 3 may have a polygonal shape, and a circumcircle diameter or an incircle diameter of the polygonal shape is 0.15-0.55 mm.

More preferably, the top sound hole area 3 may also include a plurality of sub-sound holes 30, as shown in the enlarged view of FIG. 1. Each sub-sound hole 30 may have a hexagonal shape as shown in the figure, and a circumcircle diameter or an incircle diameter of the hexagonal shape may be less than or equal to 0.05 mm. With this arrangement, the wind may be further scattered and resistance increased at the top sound hole area 3, while ensuring that sufficient sound passes through the top sound hole area 3.

According to a preferred variation, each sub-sound hole may have a polygonal shape, such as a triangular, square, or pentagonal sub-sound hole in addition to the hexagonal sub-sound hole mentioned above. The circumcircle diameter or the incircle diameter of the polygonal shape of each sub-sound hole is also less than or equal to 0.05 mm.

According to another preferred variation, each sub-sound hole 30 may have a circular shape and its diameter is also less than or equal to 0.05 mm.

More preferably, the top sound hole area 3 is formed by machining a top wall 10 of the housing 1. In this case, the top wall 10 and side walls 11 of the housing 1 may be formed integrally, and the top sound hole area 3, whether it includes a through hole or multiple sub-sound holes, is also formed together during the forming process of the housing 1. The latter top sound hole area 3 can be processed by drilling or other methods after the housing 1 is formed.

According to another preferred embodiment not shown, the microphone module may include an additional sound hole plate that may include the top sound hole area and may be connected to a top opening of the housing 1 (e.g., by welding or bonding). Providing an additional sound hole plate may facilitate the assembly of the microphone module as well as its replacement when damaged.

More preferably, one or both of the first windproof net 41 and the second windproof net 42 may have a plurality of net holes (not shown in the cross-sectional view of FIG. 1), each net hole having a circular shape and a diameter less than or equal to 0.05 mm, or each net hole having a polygonal shape (e.g., a hexagonal shape) and a circumcircle diameter or an incircle diameter of the polygonal shape being less than or equal to 0.05 mm.

On the other hand, since there is also a need for shielding electromagnetic interference in the microphone module, the housing 1 may be integrally formed of metal material, and the first windproof net 41 and the second windproof net 42 are also made of metal material. Furthermore, the first windproof net 41 and the second windproof net 42 may be welded or bonded to the housing 1.

In summary, the present invention provides a microphone module with excellent windproof and noise-reducing functions, which can ensure clear call quality in windy weather with wind speeds of up to 9 m/s or even 11 m/s. In addition, the microphone module is small and modular, and can be embedded in wearable devices of any shape.

The exemplary implementations of the present disclosure have been described in detail above with reference to preferred embodiments. However, those skilled in the art will understand that various modifications and alterations can be made to the above specific embodiments without departing from the spirit of the present disclosure, and various combinations can be made to the various technical features and structures proposed in the present disclosure without exceeding the protection scope of the present disclosure, which is determined by the appended claims.

1. A microphone module, comprising:
a housing;
a microphone unit disposed in the housing and located at a bottom of the housing;
a top sound hole area located at a top of the housing;
a first windproof net covering the top sound hole area;
a windproof cotton unit disposed between the top sound hole area and the microphone unit; and
a second windproof net disposed between the windproof cotton unit and the microphone unit.

2. The microphone module of claim 1, wherein the windproof cotton unit has a density greater than 25 kg/m³.

3. The microphone module of claim 1, wherein the windproof cotton unit has a microporous structure including a plurality of micropores, and a pore diameter of each micropore ranges from 1 μm to 1 mm.

4. The microphone module of claim 1, wherein the windproof cotton unit further comprises ceramic sponge, open-cell foamed plastic, or sponge rubber.

5. The microphone module of claim 1, wherein a surface of the windproof cotton unit opposite to the first windproof net includes a plurality of protrusions or a plurality of recesses.

6. The microphone module of claim 1, wherein a surface of the windproof cotton unit opposite to the first windproof net includes a plurality of protrusions and a plurality of recesses, wherein the plurality of protrusions and the plurality of recesses form a corrugated texture, and the plurality of protrusions constitute crests of the corrugated texture, and the plurality of recesses constitute troughs of the corrugated texture, wherein a shape of each crest and trough is one of arc-shaped, triangular, sinusoidal, or square.

7. The microphone module of claim 1, wherein the top sound hole area has a circular shape and a diameter D of 0.15-0.55 mm.

8. The microphone module of claim 7, wherein:
the top sound hole area is formed by machining a top wall of the housing; or
the microphone module comprises a sound hole plate that is connected to a top opening of the housing and includes the top sound hole area.

9. The microphone module of claim 7, wherein the top sound hole area includes a plurality of sub-sound holes, and wherein:
each sub-sound hole has a polygonal shape, and a circumcircle diameter or an incircle diameter of the polygonal shape of each sub-sound hole is less than or equal to 0.05 mm; or
each sub-sound hole has a circular shape and a diameter less than or equal to 0.05 mm.

10. The microphone module of claim 1, wherein the top sound hole area has a polygonal shape, and a circumcircle diameter or an incircle diameter of the polygonal shape is 0.15-0.55 mm.

11. The microphone module of claim 10, wherein:
the top sound hole area is formed by machining a top wall of the housing; or
the microphone module comprises a sound hole plate that is connected to a top opening of the housing and includes the top sound hole area.

12. The microphone module of claim 1, wherein one or both of the first windproof net and the second windproof net have a plurality of net holes, each net hole having a circular shape and a diameter less than or equal to 0.05 mm, or each net hole having a polygonal shape and a circumcircle diameter or an incircle diameter of the polygonal shape being less than or equal to 0.05 mm.

13. The microphone module of claim 1, wherein the housing is integrally formed of metal material, and the first windproof net and the second windproof net are made of metal material.

14. A microphone module for a wearable device, comprising:
a housing mounted in the wearable device;
a microphone unit disposed in the housing and located at a bottom of the housing;
a top sound hole area located at a top of the housing;
a first windproof net covering the top sound hole area;
a windproof cotton unit disposed between the top sound hole area and the microphone unit; and
a second windproof net disposed between the windproof cotton unit and the microphone unit.

15. The microphone module for a wearable device of claim 14, wherein a surface of the windproof cotton unit opposite to the first windproof net includes a plurality of protrusions or a plurality of recesses.

16. The microphone module for a wearable device as claimed in claim 14, wherein a surface of the windproof cotton unit opposite to the first windproof net includes a plurality of protrusions and a plurality of recesses, wherein the plurality of protrusions and the plurality of recesses form a corrugated texture, and the plurality of protrusions constitute crests of the corrugated texture, and the plurality of recesses constitute troughs of the corrugated texture, wherein a shape of each crest and trough is one of arc-shaped, triangular, sinusoidal, or square.

17. The microphone module for a wearable device as claimed in claim 14, wherein the top sound hole area has a circular shape and a diameter D of 0.15-0.55 mm; and
the top sound hole area is formed by machining a top wall of the housing; or
the microphone module comprises a sound hole plate that is connected to a top opening of the housing and includes the top sound hole area.

18. The microphone module for a wearable device as claimed in claim 14, wherein the top sound hole area has a polygonal shape and a circumcircle diameter, or an incircle diameter of the polygonal shape is 0.15-0.55 mm; and
the top sound hole area is formed by machining a top wall of the housing or the microphone module comprises a sound hole plate that is connected to a top opening of the housing and includes the top sound hole area.

19. The microphone module for a wearable device as claimed in claim 14, wherein:
one or both of the first windproof net and the second windproof net have a plurality of net holes; and
each net hole having a circular shape and a diameter less than or equal to 0.05 mm; or
each net hole having a polygonal shape and a circumcircle diameter or an incircle diameter of the polygonal shape being less than or equal to 0.05 mm.

20. The microphone module for wearable device as claimed in claim 14, wherein the housing is integrally formed of metal material, and the first windproof net and the second windproof net are made of metal material.
